(19) United States
(12) Patent Application Publication
(10) Pub. No.: US 2016/0146134 A1
(43) Pub. Date: May 26, 2016

(54) METHOD OF MODEL-BASED MULTIVARIABLE CONTROL OF EGR, FRESH MASS AIR FLOW, AND BOOST PRESSURE FOR DOWNSIZE BOOSTED ENGINES

(71) Applicant: GM GLOBAL TECHNOLOGY OPERATIONS LLC, Detroit, MI (US)

(72) Inventors: YUE-YUN WANG, TROY, MI (US); IBRAHIM HASKARA, MACOMB, MI (US); VINCENZO ALFIERI, TORINO (IT); GIUSEPPE CONTE, TORINO (IT)

(21) Appl. No.: 14/549,067

(22) Filed: Nov. 20, 2014

(51) Int. Cl. F02D 41/00

(52) U.S. Cl. CPC F02D 41/0052; F02D 41/0007; F02D 2041/0017

(57) ABSTRACT

An engine includes an exhaust gas recirculation system, an air throttle system, and a charging system. A method to control the engine includes monitoring desired operating target commands for each of the systems; monitoring operating parameters of the air charging system; and determining a feedback control signal for each of the systems based upon the respective desired operating target commands and the operating parameters of the air charging system. Exhaust gas recirculation flow in the exhaust gas recirculation system, air flow in the air throttle system and a turbine power parameter in the air charging system are determined based upon the respective feedback control signals for each of the systems. A system control command is determined for each of the systems based upon the respective exhaust gas recirculation flow, air flow and turbine power parameters. The air charging system is controlled based upon the system control commands for each of the systems.

### TECHNICAL FIELD

This disclosure is related to control of internal combustion engines

### BACKGROUND

The statements in this section merely provide background information related to the present disclosure. Accordingly, such statements are not intended to constitute an admission of prior art.

Engine control includes control of parameters in the operation of an engine based upon a desired engine output, including an engine speed and an engine load, and resulting operation, for example, including engine emissions. Parameters controlled by engine control methods include air flow, fuel flow, and intake and exhaust valve settings.

Boost air can be provided to an engine to provide an increased flow of air to the engine relative to a naturally aspirated intake system to increase the output of the engine. A turbocharger utilizes pressure in an exhaust system of the engine to drive a compressor providing boost air to the engine. Exemplary turbochargers can include variable geometry turbochargers (VGT), enabling modulation of boost air provided for given conditions in the exhaust system. A supercharger utilizes mechanical power from the engine, for example as provided by an accessory belt, to drive a compressor providing boost air to the engine. Engine control methods control boost air in order to control the resulting combustion within the engine and the resulting output of the engine.

Exhaust gas recirculation (EGR) is another parameter that can be controlled by engine controls. An exhaust gas flow within the exhaust system of an engine is depleted of oxygen and is essentially an inert gas. When introduced to or retained within a combustion chamber in combination with a combustion charge of fuel and air, the exhaust gas moderates the combustion, reducing an output and an adiabatic flame temperature. EGR can also be controlled in combination with other parameters in advanced combustion strategies, for example, including homogeneous charge compression ignition (HCCI) combustion. EGR can also be controlled to change properties of the resulting exhaust gas flow. Engine control methods control EGR in order to control the resulting combustion within the engine and the resulting output of the engine.

Air handling systems for an engine manage the flow of intake air and EGR into the engine. Air handling systems must be equipped to meet charge air composition targets (e.g. an EGR fraction target) to achieve emissions targets, and meet total air available targets (e.g. the charge flow mass flow) to achieve desired power and torque targets. The actuators that most strongly affect EGR flow generally affect charge flow, and the actuators that most strongly affect charge flow generally affect EGR flow. Therefore, an engine with a modern air handling system presents a multiple input multiple output (MIMO) system with coupled input-output response loops.

MIMO systems, where the inputs are coupled, i.e. the input-output response loops affect each other, present well known challenges in the art. An engine air handling system presents further challenges. The engine operates over a wide range of parameters including variable engine speeds, variable torque outputs, and variable fueling and timing schedules. In many cases, exact transfer functions for the system are unavailable and/or the computing power needed for a standard decoupling calculation is not available.

### SUMMARY

An engine includes an exhaust gas recirculation system, an air throttle system, and a charging system. A method to control the engine includes monitoring desired operating target commands for each of the exhaust gas recirculation system, the air throttle system, and the air charging system; monitoring operating parameters of the air charging system; and determining a feedback control signal for each of the exhaust gas recirculation system, the air throttle system, and the air charging system based upon the respective desired operating target commands and the operating parameters of the air charging system. Exhaust gas recirculation flow in the exhaust gas recirculation system, air flow in the air throttle system and a turbine power parameter in the air charging system are determined based upon the respective feedback control signals for each of the exhaust gas recirculation system, the air throttle system and the air charging system. A system control command is determined for each of the exhaust gas recirculation system, the air throttle system, and the air charging system based upon the respective exhaust gas recirculation flow, air flow and turbine power parameters. The air charging system is controlled based upon the system control commands for each of the exhaust gas recirculation system, the air throttle system, and the air charging system.

### BRIEF DESCRIPTION OF THE DRAWINGS

One or more embodiments will now be described, by way of example, with reference to the accompanying drawings, in which:

FIG. 1 schematically depicts an exemplary internal combustion engine, control module, and exhaust aftertreatment system, in accordance with the present disclosure;

FIG. 2 schematically depicts an exemplary engine configuration including a turbocharger, an accordance with the present disclosure;

FIG. 3 schematically depicts an exemplary engine configuration including a supercharger, in accordance with the present disclosure;

FIG. 4 schematically depicts an exemplary air charging multivariable nonlinear control system, using state feedback linearization control, in accordance with the present disclosure;

FIG. 5 schematically depicts an exemplary air charging multivariable control system, using model-based feedforward control and PID feedback control methods, in accordance with the present disclosure;

FIG. 6 schematically depicts an exemplary air charging multivariable control system, using model-based feedforward control and MPC feedback control methods, in accordance with the present disclosure;

FIG. 7 schematically depicts an exemplary air charging multivariable control system, using model-based feedforward control and LQR feedback control methods, in accordance with the present disclosure; and

FIG. 8 depicts an exemplary process, in accordance with the present disclosure.

### DETAILED DESCRIPTION

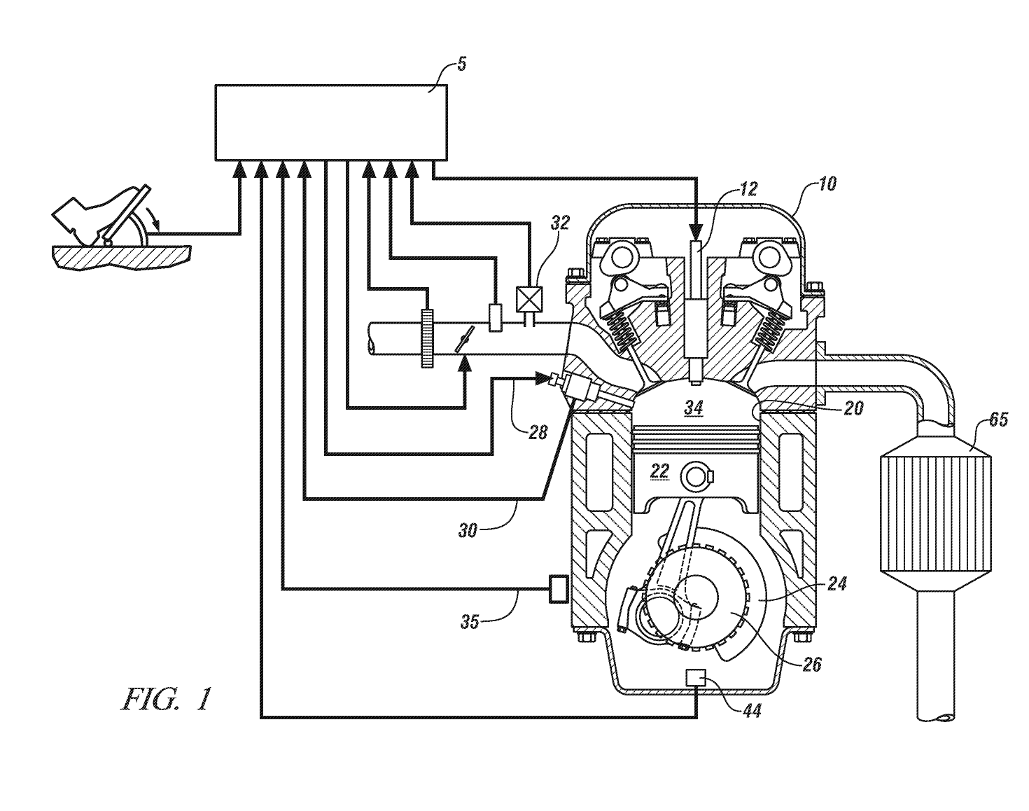

Referring now to the drawings, wherein the showings are for the purpose of illustrating certain exemplary embodiments only and not for the purpose of limiting the same, FIG. 1 schematically depicts an exemplary internal combustion engine 10, control module 5, and exhaust aftertreatment system 65, in accordance with the present disclosure. The exemplary engine includes a multi-cylinder, direct-injection, compression-ignition internal combustion engine having reciprocating pistons 22 attached to a crankshaft 24 and movable in cylinders 20 which define variable volume combustion chambers 34. The crankshaft 24 is operably attached to a vehicle transmission and driveline to deliver tractive torque thereto, in response to an operator torque request, T_{O}_{_}_{REQ}. The engine preferably employs a four-stroke operation wherein each engine combustion cycle includes 720 degrees of angular rotation of crankshaft 24 divided into four 180-degree stages (intake-compression-expansion-exhaust), which are descriptive of reciprocating movement of the piston 22 in the engine cylinder 20. A multi-tooth target wheel 26 is attached to the crankshaft and rotates therewith. The engine includes sensors to monitor engine operation, and actuators which control engine operation. The sensors and actuators are signally or operatively connected to control module 5.

The engine is preferably a direct-injection, four-stroke, internal combustion engine including a variable volume combustion chamber defined by the piston reciprocating within the cylinder between top-dead-center and bottom-dead-center points and a cylinder head including an intake valve and an exhaust valve. The piston reciprocates in repetitive cycles each cycle including intake, compression, expansion, and exhaust strokes.

The engine preferably has an air/fuel operating regime that is primarily lean of stoichiometry. One having ordinary skill in the art understands that aspects of the disclosure are applicable to other engine configurations that operate either at stoichiometry or primarily lean of stoichiometry, e.g., lean-burn spark-ignition engines or the conventional gasoline engines. During normal operation of the compression-ignition engine, a combustion event occurs during each engine cycle when a fuel charge is injected into the combustion chamber to form, with the intake air, the cylinder charge. The charge is subsequently combusted by action of compression thereof during the compression stroke.

The engine is adapted to operate over a broad range of temperatures, cylinder charge (air, fuel, and EGR) and injection events. The methods disclosed herein are particularly suited to operation with direct-injection compression-ignition engines operating lean of stoichiometry to determine parameters which correlate to heat release in each of the combustion chambers during ongoing operation. The methods are further applicable to other engine configurations, including spark-ignition engines, including those adapted to use homogeneous charge compression ignition (HCCI) strategies. The methods are applicable to systems utilizing multi-pulse fuel injection events per cylinder per engine cycle, e.g., a system employing a pilot injection for fuel reforming, a main injection event for engine power, and where applicable, a post-combustion fuel injection event for aftertreatment management, each which affects cylinder pressure.

Sensors are installed on or near the engine to monitor physical characteristics and generate signals which are correlatable to engine and ambient parameters. The sensors include a crankshaft rotation sensor, including a crank sensor 44 for monitoring crankshaft (i.e. engine) speed (RPM) through sensing edges on the teeth of the multi-tooth target wheel 26. The crank sensor is known, and may include, e.g., a Hall-effect sensor, an inductive sensor, or a magnetoresistive sensor. Signal output from the crank sensor 44 is input to the control module 5. A combustion pressure sensor 30 is adapted to monitor in-cylinder pressure (COMB_PR). The combustion pressure sensor 30 is preferably non-intrusive and includes a force transducer having an annular cross-section that is adapted to be installed into the cylinder head at an opening for a glow-plug 28. The combustion pressure sensor 30 is installed in conjunction with the glow-plug 28, with combustion pressure mechanically transmitted through the glow-plug to the pressure sensor 30. The output signal, COMB_PR, of the pressure sensor 30 is proportional to cylinder pressure. The pressure sensor 30 includes a piezoceramic or other device adaptable as such. Other sensors preferably include a manifold pressure sensor for monitoring manifold pressure (MAP) and ambient barometric pressure (BARO), a mass air flow sensor for monitoring intake mass air flow (MAF) and intake air temperature (T_{IN}), and a coolant sensor 35 monitoring engine coolant temperature (COOLANT). The system may include an exhaust gas sensor for monitoring states of one or more exhaust gas parameters, e.g., temperature, air/fuel ratio, and constituents. One skilled in the art understands that there may be other sensors and methods for purposes of control and diagnostics. The operator input, in the form of the operator torque request, T_{O}_{_}_{REQ}, is typically obtained through a throttle pedal and a brake pedal, among other devices. The engine is preferably equipped with other sensors for monitoring operation and for purposes of system control. Each of the sensors is signally connected to the control module 5 to provide signal information which is transformed by the control module to information representative of the respective monitored parameter. It is understood that this configuration is illustrative, not restrictive, including the various sensors being replaceable with functionally equivalent devices and routines.

The actuators are installed on the engine and controlled by the control module 5 in response to operator inputs to achieve various performance goals. Actuators include an electronically-controlled throttle valve which controls throttle opening in response to a control signal (ETC), and a plurality of fuel injectors 12 for directly injecting fuel into each of the combustion chambers in response to a control signal (INJ_PW), all of which are controlled in response to the operator torque request, T_{O}_{_}_{REQ}. An exhaust gas recirculation valve 32 and cooler control flow of externally recirculated exhaust gas to the engine intake, in response to a control signal (EGR) from the control module. A glow-plug 28 is installed in each of the combustion chambers and adapted for use with the combustion pressure sensor 30. Additionally, a charging system can be employed in some embodiments supplying boost air according to a desired manifold air pressure.

Fuel injector 12 is a high-pressure fuel injector adapted to directly inject a fuel charge into one of the combustion chambers in response to the command signal, INJ_PW, from the control module. Each of the fuel injectors 12 is supplied pressurized fuel from a fuel distribution system, and has operating characteristics including a minimum pulsewidth and an associated minimum controllable fuel flow rate, and a maximum fuel flow rate.

The engine may be equipped with a controllable valvetrain operative to adjust openings and closings of intake and exhaust valves of each of the cylinders, including any one or more of valve timing, phasing (i.e., timing relative to crank angle and piston position), and magnitude of lift of valve openings. One exemplary system includes variable cam phasing, which is applicable to compression-ignition engines, spark-ignition engines, and homogeneous-charge compression ignition engines.

The control module 5 executes routines stored therein to control the aforementioned actuators to control engine operation, including throttle position, fuel injection mass and timing, EGR valve position to control flow of recirculated exhaust gases, glow-plug operation, and control of intake and/or exhaust valve timing, phasing, and lift on systems so equipped. The control module is configured to receive input signals from the operator (e.g., a throttle pedal position and a brake pedal position) to determine the operator torque request, T_{O}_{_}_{REQ}, and from the sensors indicating the engine speed (RPM) and intake air temperature (Tin), and coolant temperature and other ambient conditions.

Control module, module, controller, control unit, processor and similar terms mean any suitable one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the desired functionality. The control module has a set of control routines, including resident software program instructions and calibrations stored in memory and executed to provide the desired functions. The routines are preferably executed during preset loop cycles. Routines are executed, such as by a central processing unit, and are operable to monitor inputs from sensors and other networked control modules, and execute control and diagnostic routines to control operation of actuators. Loop cycles may be executed at regular intervals, for example each 3.125, 6.25, 12.5, 25 and 100 milliseconds during ongoing engine and vehicle operation. Alternatively, routines may be executed in response to occurrence of an event.

FIG. 1 depicts an exemplary diesel engine, however, the present disclosure can be utilized on other engine configurations, for example, including gasoline-fueled engines, ethanol or E85 fueled engines, or other similar known designs. The disclosure is not intended to be limited to the particular exemplary embodiments disclosed herein.

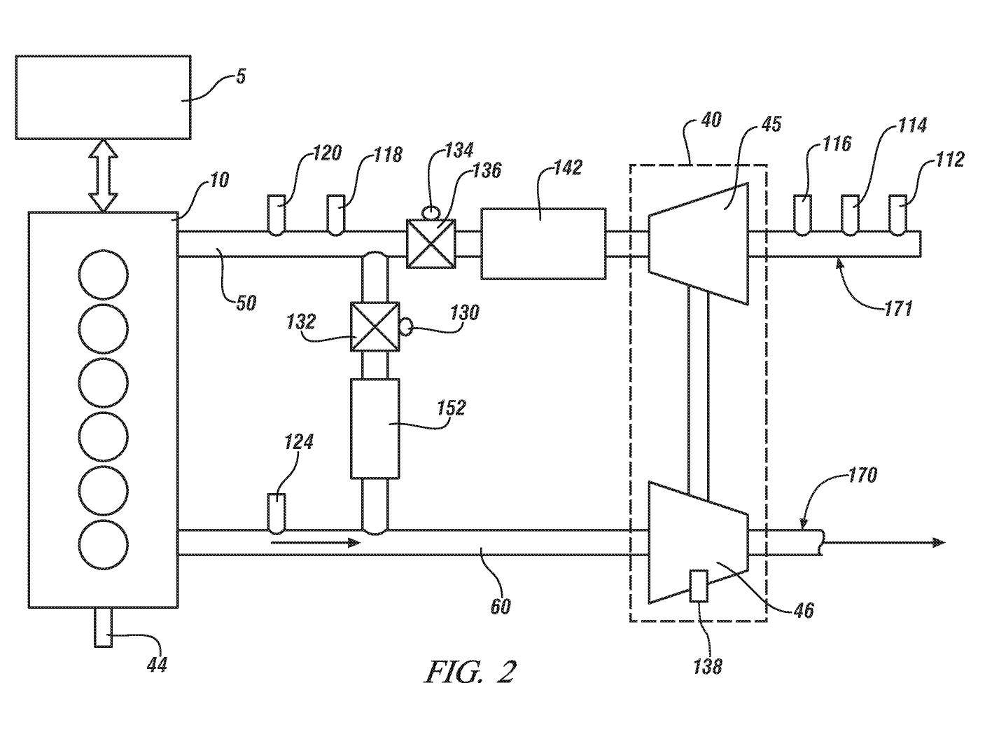

FIG. 2 schematically depicts an exemplary engine configuration including a turbocharger, in accordance with the present disclosure. The exemplary engine is multi-cylinder and includes a variety of fueling types and combustion strategies known in the art. Engine system components include an intake air compressor 40 including a turbine 46 and an air compressor 45, an air throttle valve 136, a charge air cooler 142, an EGR valve 132 and cooler 152, an intake manifold 50, and exhaust manifold 60. Ambient intake air is drawn into compressor 45 through intake 171. Pressurized intake air and EGR flow are delivered to intake manifold 50 for use in engine 10. Exhaust gas flow exits engine 10 through exhaust manifold 60, drives turbine 46, and exits through exhaust tube 170. The depicted EGR system is a high pressure EGR system, delivering pressurized exhaust gas from exhaust manifold 60 to intake manifold 50. An alternative configuration, a low pressure EGR system, can deliver low pressure exhaust gas from exhaust tube 170 to intake 171. Sensors are installed on the engine to monitor physical characteristics and generate signals which are correlatable to engine and ambient parameters. The sensors preferably include an ambient air pressure sensor 112, an ambient or intake air temperature sensor 114, and a mass air flow sensor 116 (all which can be configured individually or as a single integrated device), an intake manifold air temperature sensor 118, an MAP sensor 120, an exhaust gas temperature sensor 124, an air throttle valve position sensor 134 and an EGR valve position sensor 130, and a turbine vane position sensor 138. Engine speed sensor 44 monitors rotational speed of the engine. Each of the sensors is signally connected to the control module 5 to provide signal information which is transformed by the control module 5 to information representative of the respective monitored parameter. It is understood that this configuration is illustrative, not restrictive, including the various sensors being replaceable within functionally equivalent devices and routines and still fall within the scope of the disclosure. Furthermore, the intake air compressor 40 may include alternative turbocharger configurations within the scope of this disclosure.

The intake air compressor 40 includes a turbocharger including an air compressor 45 positioned in the air intake of the engine which is driven by turbine 46 that is positioned in the exhaust gas flowstream. Turbine 46 can include a number of embodiments, including a device with fixed vane orientations or variable vane orientations. Further, a turbocharger can be used as a single device, or multiple turbochargers can be used to supply boost air to the same engine.

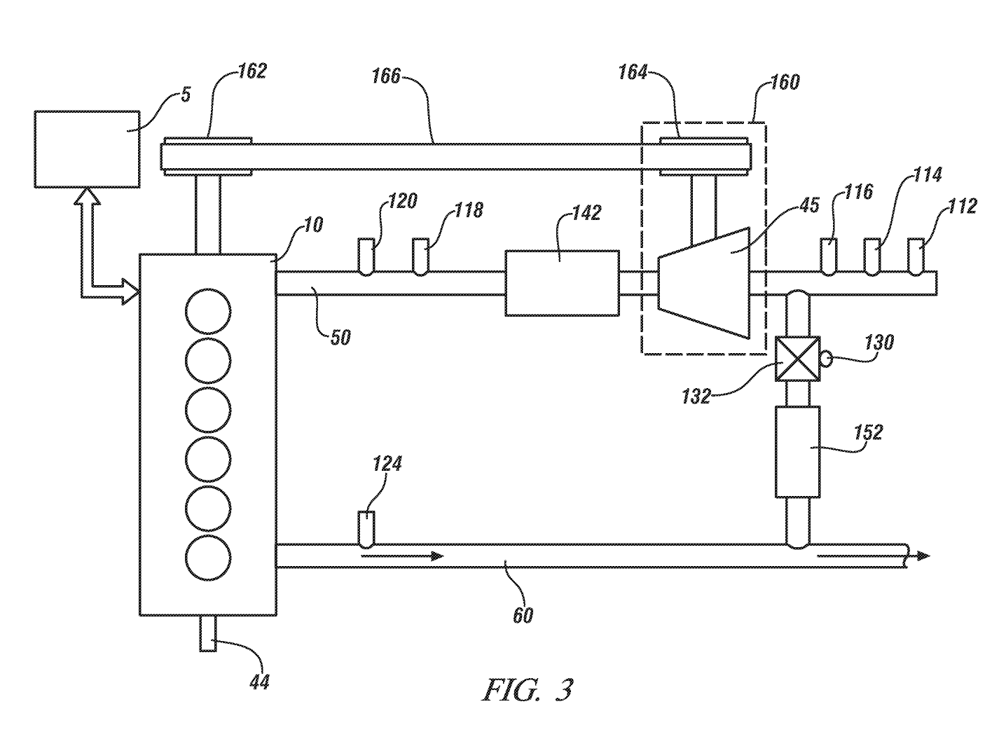

FIG. 3 schematically depicts an exemplary engine configuration including a supercharger, in accordance with the present disclosure. The exemplary engine is multi-cylinder and includes a variety of fueling types and combustion strategies known in the art. Engine system components include a supercharger 160 comprising an air compressor 45 and a belt driven wheel 164, a charge air cooler 142, an EGR valve 132 and cooler 152, an intake manifold 50, and exhaust manifold 60. Engine 10 includes driven wheel 162, providing power to belt 166 driving belt driven wheel 164. An exemplary belt 166 can include a configuration known in the art as a serpentine belt. Exemplary configurations include belt 166 driving the supercharger 160 and other accessories such as an alternator or an air conditioning compressor simultaneously. Sensors are installed on the engine to monitor physical characteristics and generate signals which are correlatable to engine and ambient parameters. The sensors preferably include an ambient air pressure sensor 112, an ambient or intake air temperature sensor 114, and a mass air flow sensor 116 (all which can be configured individually or as a single integrated device), an intake manifold air temperature sensor 118, MAP sensor 120, an exhaust gas temperature sensor 124 and an EGR valve position sensor 130. Exemplary EGR valve 130 and EGR cooler 152 provide a path for EGR flow to enter the intake system upstream of the supercharger 160. Under other configurations, the EGR flow can enter the intake system downstream of the supercharger 160, although it will be appreciated that high pressure downstream of the supercharger can limit conditions in which the EGR flow will effectively enter the intake under this configuration. Engine speed sensor 44 monitors rotational speed of the engine. Each of the sensors is signally connected to the control module 5 to provide signal information which is transformed by the control module 5 to information representative of the respective monitored parameter. It is understood that this configuration is illustrative, not restrictive, including the various sensors being replaceable within functionally equivalent devices and routines and still fall within the scope of the disclosure. Supercharger 160 can be used to provide boost air to an engine, or supercharger 160 can be used in cooperation with a turbocharger to provide boost air to an engine.

Variable geometry turbochargers (VGT) enable control of how much compression is performed on intake air. A control signal can modulate operation of the VGT, for example, by modulating an angle of the vanes in the compressor and/or turbine. Such exemplary modulation can decrease the angle of such vanes, decreasing compression of the intake air, or increase the angle of such vanes, increasing compression of the intake air. VGT systems allow a control module to select a level of boost pressure delivered to the engine. Other methods of controlling a variable charger output, for example, including a waste gate or a bypass valve, can be implemented similarly to a VGT system, and the disclosure is not intended to be limited to the particular exemplary embodiments disclosed herein for controlling boost pressure delivered to the engine.

Exemplary diesel engines are equipped with common rail fuel-injection systems, EGR systems, and VGT systems. Exhaust gas recirculation is used to controllably decrease combustion flaming temperature and reduce NOx emissions. VGT systems are utilized to modulate boost pressures to control a manifold air pressure and increase engine output. To accomplish engine control including control of the EGR and VGT systems, a multi-input multi-output air charging control module (MIMO module) can be utilized. A MIMO module enables computationally efficient and coordinated control of EGR and VGT based upon a single set of inputs describing desired engine operation. Such input, for example, can include an operating point for the engine describing an engine speed and an engine load. It will be appreciated that other parameters can be utilized as input, for example, including pressure measurements indicating an engine load.

Coupled MIMO control of both EGR and VGT, or control fixing response of both EGR and VGT based upon any given input, is computationally efficient and can enable complex control responses to changing inputs that might not be computationally possible in real-time based upon independent control of EGR and VGT. However, coupled control of EGR and VGT, including fixed responses of both parameters for any given input, requires simplified or best fit calibrations of the coupled controls in order to control both fixed responses. As a result, such calibrations can be challenging and can include less than optimal engine performance based upon the simplified control calibrations selected. EGR and VGT, for example, might optimally react differently to a rate of change in load or to engine temperatures. Additionally, control of EGR or VGT can reach limit conditions and result in actuator saturation. Coupled control resulting in actuator saturation can cause a condition known in the art as wind-up wherein expected behavior of the system and desired control of the system diverge and result in control errors even after the actuator saturation has been resolved. Additionally, control of EGR and VGT by a MIMO module is nonlinear, and defining the coupled functional relationships to provide the desired control outputs requires extensive calibration work.

VGT commands are one way to control boost pressure. However, other commands controlling a boost pressure such as a boost pressure command or a manifold air pressure command can be utilized similarly in place of VGT commands.

The engine configuration, such as the exemplary engine configuration, including a turbocharger, as is schematically depicted in FIG. 2 may be represented by a mathematical model. Model-based nonlinear control may be applied to transform desired air and charging targets to individual flow or power for each actuator, such as exhaust gas recirculation flow, intake air flow, and turbine power. An actuator position for each of the EGR valve, air throttle valve, and the VGT control can be uniquely determined based on the individual flow or power values, additionally resulting in a decoupled and nearly linearized system for feedback control. A method to control an engine including EGR, air throttle and air charging control includes utilizing physics model-based feedforward control, or feedback linearization control to decouple the controls of a multivariable system.

An exemplary system model for the model based nonlinear control can be expressed by a nonlinear differential equation as set forth in the following relationship.

\dot{y}=F(y)+Bu [1]

The MIMO feedforward control applied to the inputs u in the exemplary system model expressed above can be expressed by the following relationship.

u=−B⁻¹F(y)+B⁻¹v [2]

The term −B⁻¹F(y) expresses the feedback linearization of the system if y is an actual measured or estimated parameter from the system, or it expresses the feedforward control of the system if y is replaced by its desired reference command to track. The feedback controller v can utilize proportional-integral-derivative (PID), linear quadratic regulator (LQR), or model predictive control (MPC) feedback control methods with minimum gains scheduling required. The multivariable system output vector \dot{y} can be decoupled into a linear SISO feedback system, as is expressed by the following relationship.

$$\dot{y} = [ \begin{matrix}{\dot{y}}_{1} \\ {\dot{y}}_{2} \\ ⋮ \\ {\dot{y}}_{n}\end{matrix} ] = [ \begin{matrix}{v}_{1} \\ {v}_{2} \\ ⋮ \\ {v}_{n}\end{matrix} ] = v \qquad [ 3 ]$$

The input vector u is input into the system model which applies model-based multivariable feedforward control to replace lookup tables, and additionally applies feedback control to improve tracking against unmodeled uncertainties. The output vector \dot{y} is then decoupled into linear SISO feedback vector v.

A first exemplary physics based air and charging system model of the exemplary engine configuration, including a turbocharger as is schematically depicted in FIG. 2 is expressed, in accordance with the basic system model relationships [1], [2] and [3] set forth above, by the following set of relationships.

$$\begin{matrix}{\dot{p}}_{rc} = - {cP}_{c} ( {p}_{rc} , \frac{{W}_{itv} \sqrt{{T}_{a}}}{{p}_{a}} ) + J ( {\dot{W}}_{itv} , {W}_{itv} ) + {cP}_{t} & [ 4 ] \\ {\dot{p}}_{i} = \frac{{RT}_{im}}{{V}_{i}} ( {W}_{itv} + {W}_{egr} - {W}_{e} ( {p}_{i} ) ) & [ 5 ] \\ {\dot{F}}_{i} = \frac{( {F}_{x} - {F}_{i} ) {W}_{egr} - {F}_{i} {W}_{itv}}{{m}_{i}} & [ 6 ]\end{matrix}$$

A second alternative exemplary physics based air and charging system model of the exemplary engine configuration, including a turbocharger as is schematically depicted in FIG. 2 may be expressed, again in accordance with the basic system model relationships [1], [2] and [3] set forth above, by the following set of relationships:

$$\begin{matrix}{\dot{p}}_{c \_ ds} = \frac{{cT}_{c \_ ds}}{{v}_{int}} ( {W}_{c} - {W}_{itv} ) = \frac{{cT}_{c \_ ds}}{{v}_{int}} ( \frac{{h}_{t} {R}_{t}}{{c}_{p} {T}_{c \_ u s} {R}_{c}} - {W}_{itv} ) & [ 7 ] \\ {\dot{p}}_{i} = \frac{{RT}_{im}}{{V}_{i}} ( {W}_{itv} + {W}_{egr} - {W}_{e} ( {p}_{i} ) ) & [ 8 ] \\ {\dot{F}}_{i} = \frac{( {F}_{x} - {F}_{i} ) {W}_{egr} - {F}_{i} {W}_{itv}}{{m}_{i}} & [ 9 ]\end{matrix}$$

In each of these alternative three-state models as set forth in the corresponding sets of relationships ([4], [5], [6]) or ([7], [8], [9]), it will be appreciated that relationships [5] and [8] are equivalent and relationships [6] and [9] are equivalent, wherein:

pᵢ is the engine intake pressure at the intake manifold,

R is the universal gas constant, known in the art,

Tᵢₘ is the intake manifold temperature,

Vᵢ is the intake manifold volume,

Wᵢₜᵥ is the air throttle valve flow (air flow),

W_{egr} is flow through the EGR system,

Wₑ(pᵢ) is the total charge in the engine cylinder,

Fᵢ is the burned gas fraction in the intake manifold,

Fₓ is the burned gas fraction in the exhaust manifold, and

mᵢ is the mass in the intake manifold.

Wₑ(pᵢ) can be expressed by the following relationship:

$${W}_{e} ( {p}_{i} ) = \frac{{p}_{i} ND η}{2 {RT}_{i}} \qquad [ 10 ]$$

wherein

N is engine speed

D is engine displacement,

η is the engine volumetric efficiency, and

Tᵢ is the intake temperature

And, in each of the two alternative models set forth in the corresponding sets of relationships ([4], [5], [6]) or ([7], [8], [9]), it will be appreciated that relationships [4] and [7] are distinct, wherein with respect to relationship [4]:
p_{rc} is the compressor pressure ratio expressed as p_{c}_{_}_{ds}/pₐ wherein p_{c}_{_}_{ds} is the compressor downstream pressure (i.e. boost pressure) and pₐ is the ambient pressure,
c is a constant determined based on the relationship between the compressor pressure ratio and the square of the turbo speed,
P_{c} is the power being provided by the compressor,

$$\frac{{W}_{itv} \sqrt{{T}_{a}}}{{p}_{a}}$$

is the air throttle valve flow (Wᵢₜᵥ) corrected by the ambient temperature (Tₐ) and the ambient pressure (pₐ),
J(\dot{W}ᵢₜᵥ, Wᵢₜᵥ) is the inertia effect of the turbo shaft connecting the turbine to the compressor,
Pₜ is the turbine power, and
   wherein with respect to relationship [7]:
p_{c}_{_}_{ds} is the pressure downstream of the compressor,
c is a constant determined based on the relationship between the compressor pressure ratio and the square of the turbo speed,
T_{c}_{_}_{ds} is the temperature downstream of the compressor,
T_{c}_{_}ᵤₛ is the temperature upstream of the compressor,
W_{c} is the flow out of the compressor,
Vᵢₙₜ is the volume of the intake manifold,
Rₜ is the turbine power transfer rate, and
R_{c} is the compressor power increase ratio.

Flow through an EGR system can be modeled to estimate the flow based upon a number of known inputs. Flow through the EGR system can be modeled as flow through an orifice, wherein the orifice primarily includes an EGR valve or an orifice or venturi to a particular design. According to one exemplary embodiment, EGR flow, W_{egr}, can be modeled according to the following orifice flow relationship:

$${W}_{egr} = {A}_{egr} \frac{{P}_{x}}{\sqrt{R {T}_{egr}}} Ψ ( P R ) \qquad [ 11 ]$$

wherein
PR is a pressure ratio or ratio of intake pressure or pressure of charged air in the intake system at the outlet of the EGR system, Pᵢ, to exhaust pressure or pressure in the exhaust system at the inlet of the EGR system upstream of the charging system, Pₓ,
T_{egr} can indicate a temperature of the exhaust gas or exhaust gas temperature at the inlet of the EGR system. According to one exemplary embodiment, T_{egr} can be measured as an exit temperature of the EGR cooler,
A_{egr} is the effective flow area of the EGR system,
R is the universal gas constant, known in the art.

A critical pressure ratio, PR_{c}, can be expressed by the following relationship:

$$P {R}_{c} = {( \frac{2}{γ + 1} )}^{\frac{γ}{γ - 1}} \qquad [ 12 ]$$

wherein γ is a specific heat ratio, known in the art. If PR is greater than PR_{c}, then flow is subsonic. If PR is less than or equal to PR_{c}, then flow is choked. Ψ(PR) is a non-linear function and can be expressed by the following relationship.

$$Ψ ( P R ) = \{ \begin{matrix}\sqrt{\frac{2 γ}{γ - 1} ( P {R}^{2 / γ} - P {R}^{( γ + 1 ) / γ} )} & P {R}_{c} < P R < 1 ( subsonic ) \\ {{γ}^{1 / 2} ( \frac{2}{γ + 1} )}^{\frac{γ + 1}{2 ( γ - 1 )}} & P R \leq P {R}_{c} ( choked )\end{matrix} \qquad [ 13 ]$$

A_{egr} can be expressed as a function of EGR valve position, x_{egr}. However, based upon detailed modeling and experimental data, including a determination of heat loss through the walls of the system, a more accurate estimation for A_{egr} can be expressed as a function of x_{egr} and PR, which can be expressed by the following relationship.

A_{egr}=A_{egr}(x_{egr},PR) [14]

The relationship above assumes that the EGR system includes an outlet downstream of the charging system compressor and an inlet upstream of the charging system turbo unit or turbine. It will be appreciated that a different embodiment can be utilized with an EGR system including an outlet upstream of the charging system compressor and an inlet downstream of the charging system turbo unit or turbine or in the exhaust system of a vehicle utilizing a supercharger without a turbine. It will be appreciated that the above relationships and the associated inverse flow model can be modified for use with a number of exemplary EGR and charging system configurations, and the disclosure is not intended to be limited to the particular exemplary embodiments disclosed herein.

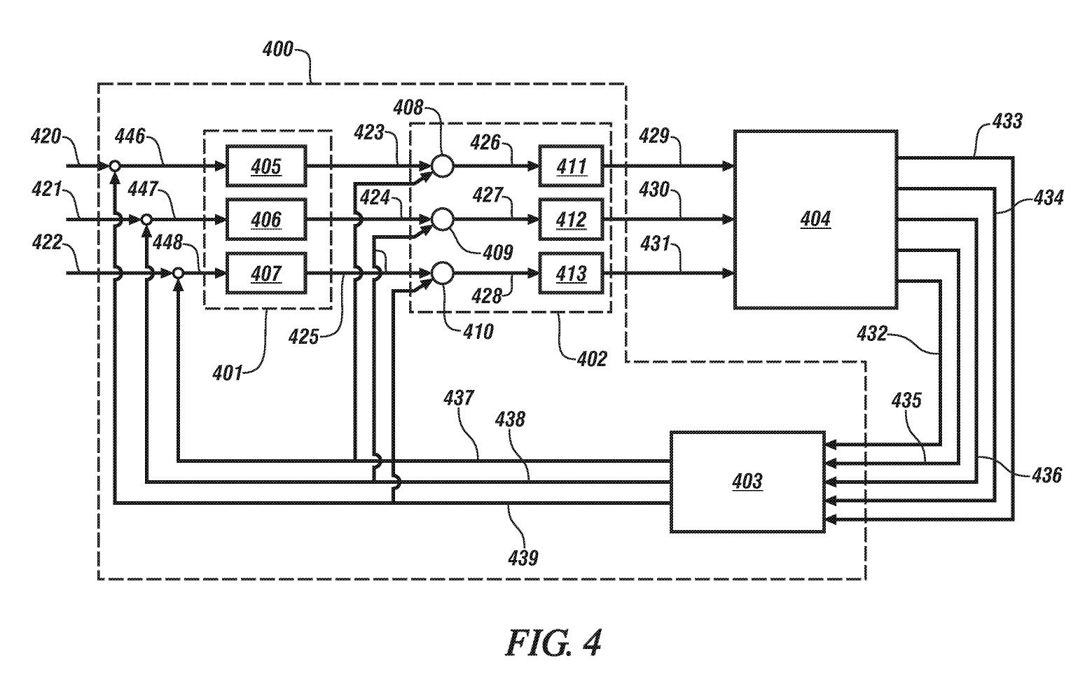

FIG. 4 schematically depicts an exemplary air charging multivariable nonlinear control system using state feedback linearization control 400, in accordance with the present disclosure. Air charging system 404 receives commands and produces outputs. A number of modules and control strategies are depicted developing the commands, including the state variable observer module 403, the linear control strategy 401 including feedback control modules 405, 406 and 407, and the nonlinear control strategy 402. Desired operating parameter points, including desired compressor pressure ratio p_{rc}_{_}_{des} 420, desired intake oxygen fraction in the intake manifold O₂_{_}_{des} 421, and desired intake manifold pressure pᵢ_{_}_{des} 422 are compared with respective feedback signals 439, 438 and 437 which are determined by either direct sensor measurements or the state variable observer module 403 based on the actual operating parameters of the air charging system 404. These operating parameters may include, for example, intake manifold pressure 432, intake manifold temperature 433, air mass 434, ambient pressure 435, and ambient temperature 436. The air charging system parameters may be monitored by sensors or alternatively estimated by the state variable observer module 403 if no sensor is present. The feedback signals describe actual compressor pressure ratio pre 439, actual oxygen fraction in the intake manifold O₂ 438, and actual intake manifold pressure pᵢ 437. The comparison of the desired operating parameters and the respective actual operating parameters determines error terms for each parameter including a compressor pressure ratio error term 446, an O₂ in the intake manifold error term 447, and an intake manifold pressure error term 448. These error terms are then input into the feedback control modules 405, 406 and 407 of the linear control strategy 401. The feedback control method implemented by each of feedback control modules 405, 406 and 407 determines feedback control signals v₁ 423, v₂ 424, and v₃ 425. Feedback control signals 423, 424 and 425, as well as feedback signals 439, 438 and 437 are input into nonlinear control strategy 402. These signals are utilized in calculating the respective air throttle valve flow Wᵢₜᵥ 426, EGR flow W_{egr} 427, and turbine power transfer rate Rₜ 428 at points 408, 409 and 410. The calculations to determine these values can be expressed by the following relationships:

$$\begin{matrix}[ \begin{matrix}{W}_{itv} \\ {W}_{egr}\end{matrix} ] = [ \begin{matrix}{r}_{air} {W}_{e} \\ {r}_{egr} {W}_{e}\end{matrix} ] + [ \begin{matrix}{r}_{air} & - 1 \\ {r}_{egr} & 1\end{matrix} ] [ \begin{matrix}{v}_{3} \\ {v}_{2}\end{matrix} ] & [ 15 ] \\ {R}_{t} = \frac{1}{{h}_{t}} ( {P}_{c} + \frac{{v}_{1}}{c} ) & [ 16 ]\end{matrix}$$

wherein
rₐᵢᵣ is the rate of fresh air with respect to total cylinder charge, and
r_{egr} is the rate of EGR with respect to total cylinder charge.
   Air throttle valve flow 426, EGR flow 427, and turbine power transfer rate 428 are then transformed into system control commands including an air throttle valve command uᵢₜᵥ 429, an EGR valve command u_{egr} 430 and VGT command u_{vgt} 431. The air throttle valve command 429, EGR valve command 430 and VGT command 431 are then used to control the air charging system 404. The transformation of the air flow 426, EGR flow 427 and turbine power transfer rate 428 into the system control commands can be achieved through the use of an inverse flow model or an inverse of a physical model of a system.

An inverse flow model or an inverse of a physical model of a system can be useful in determining settings required to achieve a desired flow through an orifice in the system. Flow through a system can be modeled as a function of a pressure difference across the system and a flow restriction in the system. Known or determinable terms can be substituted and the functional relationship manipulated to make an inverse flow model of the system useful to determine a desired system setting to achieve a desired flow. Exemplary methods disclosed herein utilize a first input of an effective flow area or of a flow restriction for the system being modeled, and a second input including a pressure value for the system of pressure moving the flow through the system. One exemplary method of decoupled feed forward control of an EGR valve can include utilizing an inverse flow model of the system embodied in a mixed polynomial based upon the inverse model and calibrated terms. Another exemplary method of decoupled feed forward control of an EGR valve can include utilizing a dimensional table-based approach. Another exemplary method of decoupled feed forward control of an EGR valve can include utilizing an exponential polyfit model. An exemplary method of decoupled feed forward control of air throttle can utilize an inverse of the physical model of the system, a dimensional table approach, or an exponential polyfit model. An exemplary method of decoupled feed forward control of a charging system, such as a turbocharger equipped with a VGT, can utilize an inverse of the physical model of the system, a dimensional table approach, or an exponential polyfit model.

These methods can be utilized individually or in combination, and different methods can be utilized for the same system for different conditions and operating ranges. A control method can utilize an inverse flow model to determine a feed forward control command for a first selection including one of the EGR circuit, the air throttle system, and the charging system. The control method can additionally utilize a second inverse flow model to determine a second feed forward control command for a second selection including another of the EGR circuit, the air throttle system, and the charging system. The control method can additionally utilize a third inverse flow model to determine a third feed forward control command for a third selection including another of the EGR circuit, the air throttle system, and the charging system. In this way, a control method can control any or all of the EGR circuit, the air throttle system, and the charging system.

A method to control EGR flow by an inverse control method according to an inverse model of EGR flow is disclosed in co-pending and commonly assigned application Ser. No. 12/982,994, corresponding to publication US 2012-0173118 A1, which is incorporated herein by reference.

Feedback control modules 405, 406 and 407 of linear control strategy 401 determine feedback control commands 423, 424 and 425 using feedback control methods. The exemplary feedback control methods used by the feedback control modules of FIG. 4 can include PID control and inputs compressor pressure ratio error term 446, air in manifold error term 447, and boost pressure error term 448. In an exemplary embodiment, the PID control modules 405, 406 and 407 can be designed individually to output decoupled feedback control signals.

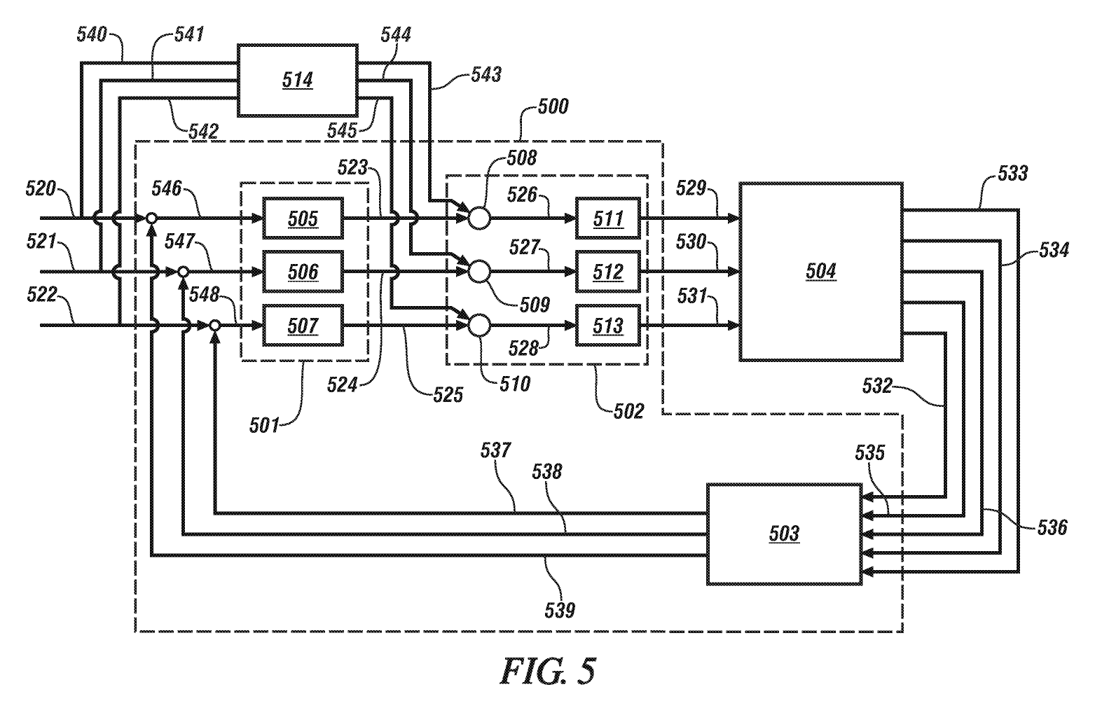

FIG. 5 schematically depicts an exemplary air charging multivariable control system, using model-based feedforward control 500 and PID feedback control methods, in accordance with the present disclosure. Air charging system 504 receives commands and produces outputs. A number of modules and control strategies are depicted developing the commands, including the state variable observer module 503, the linear control strategy 501 including feedback control modules 505, 506 and 507, and the nonlinear control strategy 502. Desired operating parameter points, including desired compressor pressure ratio p_{rc}_{_}_{des} 522, desired burned gas fraction Fᵢ 521, and desired intake manifold pressure pᵢ_{_}_{des} 520 are compared with respective feedback signals 537, 538 and 539 which are determined by either direct sensor measurements or the state variable observer module 503 based on the actual operating parameters of the air charging system 504. These operating parameters may include, for example, intake manifold pressure 532, intake manifold temperature 533, air mass 534, ambient pressure 535, and ambient temperature 536. The air charging system parameters may be monitored by sensors or alternatively estimated by the state variable observer module 503. Exemplary estimated air charging system parameters may include actual compressor pressure ratio, and exhaust manifold pressure. The monitored and estimated system operating parameters may be used to determine feedback signals. The feedback signals describe actual compressor pressure ratio 537, actual burned gas ratio 538, and actual intake manifold pressure 539. The comparison of the desired operating parameters and the respective actual operating parameters determines error terms for each parameter including an intake manifold pressure error term 546, a burned gas ratio error term 547, and a compressor pressure ratio error term 548. These error terms are then input into the feedback control modules 505, 506 and 507 of the linear control strategy 501. The PID feedback control method implemented by each of feedback control modules 505, 506 and 507 determines feedback control signals v₁ 523, v₂ 524, and v₃ 525. Desired operating parameter points, including desired compressor pressure ratio p_{rc}_{_}_{des} 522, desired burned gas fraction Fᵢ 521, and desired intake manifold pressure pᵢ_{_}_{des} 520 are additionally input into feedforward control module 514, and feedforward signals including intake manifold pressure feedforward signal 543, burned gas fraction feedforward signal 544, and compressor pressure ration feedforward signal 545 are output. The calculations to determine these feedforward signals can be expressed by the following relationships.

$$\begin{matrix}[ \begin{matrix}{W}_{itv} \\ {W}_{egr}\end{matrix} ] = [ \begin{matrix}{r}_{air} {W}_{e} \\ {r}_{egr} {W}_{e}\end{matrix} ] + [ \begin{matrix}{r}_{air} & - 1 \\ {r}_{egr} & 1\end{matrix} ] [ \begin{matrix}{v}_{3} \\ {v}_{2}\end{matrix} ] & [ 17 ] \\ {R}_{t} = \frac{1}{{h}_{t}} ( {P}_{c} + \frac{{v}_{1}}{c} ) & [ 18 ]\end{matrix}$$

Feedback control signals 523, 524 and 525, as well as feedforward signals 543, 544 and 545 are input into decoupling strategy 502. These signals are utilized in calculating the respective air throttle valve flow Wᵢₜᵥ 526, EGR flow W_{egr} 527, and turbine power transfer rate Rₜ 528 at points 508, 509 and 510 based on relationships [17] and [18]. The method of using an inverse flow model or an inverse of a physical model of a system to determine settings required to achieve a desired flow through an orifice in the system, as was discussed with reference to FIG. 4, is again applied to transform the air flow 526, EGR flow 527, and turbine power 528 into air charging system control commands. The air charging system control commands include air intake valve control command 529, EGR valve control command 530 and VGT control command 531. The air charging system 504 is then controlled to operate based on these control commands to achieve the desired operating parameters.

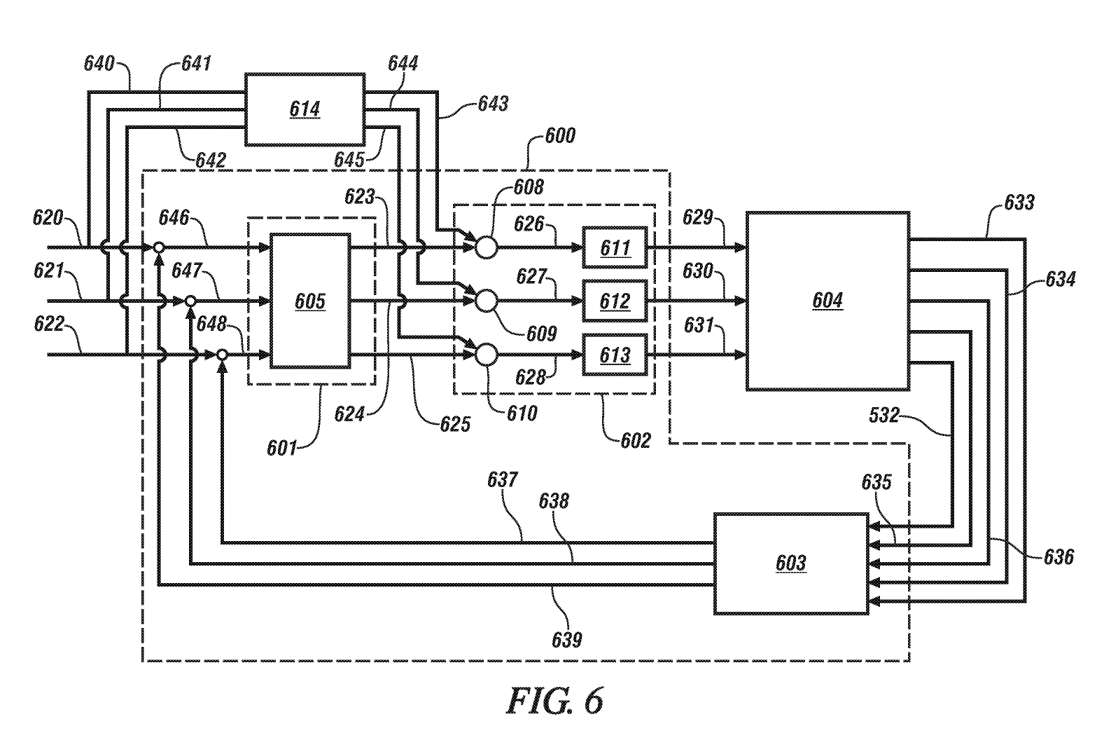

FIG. 6 schematically depicts an exemplary air charging multivariable control system, using model-based feedforward control 600 and using model predictive control (MPC) feedback control methods. Air charging system 604 receives commands and produces outputs. A number of modules and control strategies are depicted developing the commands, including the state variable observer module 603, the linear control strategy 601 including feedback control module 605, and the decoupling strategy 602. Desired operating parameter points, including desired compressor pressure ratio p_{rc}_{_}_{des} 622, desired burned gas fraction Fᵢ 621, and desired intake manifold pressure Pᵢ_{_}_{des} 620 are compared with respective feedback signals 637, 638 and 639 which are determined by the state variable observer module 603 based on the actual operating parameters of the air charging system 604. These operating parameters may include, for example, intake manifold pressure 632, intake manifold temperature 633, air mass 634, ambient pressure 635, and ambient temperature 636. The air charging system parameters may be monitored by sensors or alternatively estimated by the state variable observer module 603. Exemplary estimated air charging system parameters may include actual compressor pressure ratio, and exhaust manifold pressure. The monitored and estimated system operating parameters may be used to determine feedback signals. The feedback signals describe actual compressor pressure ratio 637, actual burned gas ratio 638, and actual intake manifold pressure 639. The comparison of the desired operating parameters and the respective actual operating parameters determines error terms for each parameter including a boost pressure error term 646, a burned gas ratio error term 647, and a compressor pressure ratio error term 648. These error terms are then input into the feedback control module 605 of the linear control strategy 601. The feedback control method implemented by feedback control module 605 can include model predictive control and inputs compressor pressure ratio error term 648, burned gas ratio error term 647, and boost pressure error term 646. The model predictive control method implemented by feedback control module 605 determines feedback control signals, including intake manifold pressure feedback control signal v₁ 623, burned gas ratio feedback control signal v₂ 624, and compressor pressure ratio feedback control signal v₃ 625. Desired operating parameter points, including desired compressor pressure ratio p_{rc}_{_}_{des} 622, desired burned gas fraction Fᵢ 621, and desired intake manifold pressure pᵢ_{_}_{des} 620 are additionally input into feedforward control module 614, and feedforward signals including intake manifold pressure feedforward signal 643, burned gas fraction feedforward signal 644, and compressor pressure ration feedforward signal 645 are output. Feedback control signals 623, 624 and 625, as well as feedforward signals 643, 644 and 645 are input into decoupling strategy 602. These signals are utilized by in calculating the respective air throttle valve flow Wᵢₜᵥ 626, EGR flow W_{egr} 627, and turbine power Pₜ 628 at points 608, 609 and 610. The calculations to determine these values can be expressed by relationships [17] and [18]. An inverse flow model or an inverse of a physical model of each system is used to transform the air flow 626, EGR flow 627, and turbine power 628 into air charging system control commands. The air charging system control commands include air intake valve control command 629, EGR valve control command 630 and VGT control command 631. The air charging system 604 is then controlled to operate based on these control commands to achieve the desired operating parameters.

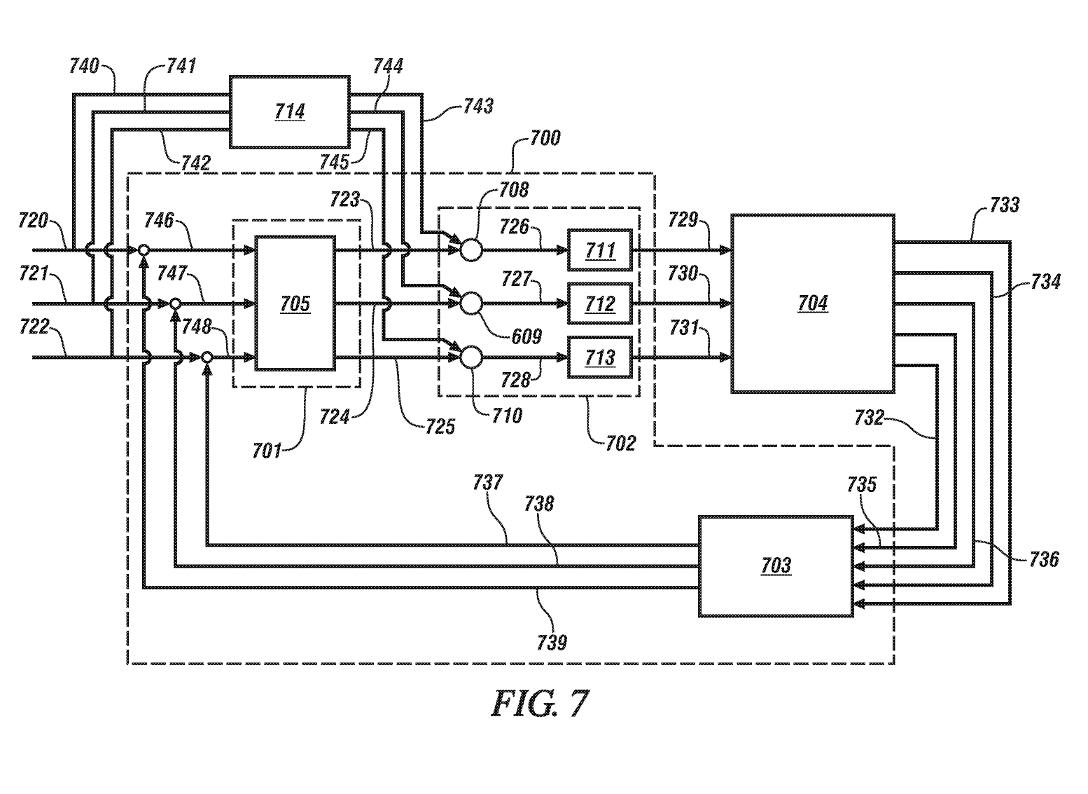

FIG. 7 schematically depicts an exemplary air charging multivariable control system, using model-based feedforward control 700 and using linear quadratic regulator (LQR) feedback control methods. Air charging system 704 receives commands and produces outputs. A number of modules and control strategies are depicted developing the commands, including the state variable observer module 703, the linear control strategy 701 including feedback control module 705, and the decoupling strategy 702. Desired operating parameter points, including desired compressor pressure ratio p_{rc}_{_}_{des} 722, desired burned gas fraction Fᵢ 721, and desired intake manifold pressure pᵢ_{_}_{des} 720 are compared with respective feedback signals 737, 738 and 739 which are determined by the state variable observer module 703 based on the actual operating parameters of the air charging system 704. These operating parameters may include, for example, intake manifold pressure 732, intake manifold temperature 733, air mass 734, ambient pressure 735, and ambient temperature 736. The air charging system parameters may be monitored by sensors or alternatively estimated by the state variable observer module 703. Exemplary estimated air charging system parameters may include actual compressor pressure ratio, and exhaust manifold pressure. The monitored and estimated system operating parameters may be used to determine feedback signals. The feedback signals describe actual compressor pressure ratio 737, actual burned gas ratio 738, and actual intake manifold pressure 739. The comparison of the desired operating parameters and the respective actual operating parameters determines error terms for each parameter including an intake manifold pressure error term 746, a burned gas ratio error term 747, and a compressor pressure ratio error term 748. These error terms are then input into the feedback control module 705 of the linear control strategy 701. The feedback control method implemented by feedback control module 705 can include linear quadratic regulator control, as is known in the art, and inputs compressor pressure ratio error term 748, burned gas ratio error term 747, and intake manifold pressure error term 746. The LQR control method implemented by feedback control module 705 determines feedback control signals, including intake manifold pressure control signal v₁ 723, burned gas ratio control signal v₂ 724, and compressor pressure ratio control signal v₃ 725. Desired operating parameter points, including desired compressor pressure ratio p_{rc}_{_}_{des} 722, desired burned gas fraction Fᵢ 721, and desired intake manifold pressure pᵢ_{_}_{des} 720 are additionally input into feedforward control module 714, and feedforward signals including intake manifold pressure feedforward signal 743, burned gas fraction feedforward signal 744, and compressor pressure ration feedforward signal 745 are output. Feedback control signals 723, 724 and 725, as well as feedforward signals 743, 744 and 745 are input into decoupling strategy 702. These signals are utilized by in calculating the respective air throttle valve flow Wᵢₜᵥ 726, EGR flow W_{egr} 727, and turbine power Pₜ 728 at calculations 708, 709 and 710. The calculations to determine these values can be expressed by relationships [17] and [18]. An inverse flow model or an inverse of a physical model of each system is used to transform the air flow 726, EGR flow 727, and turbine power 728 into air charging system control commands. The air charging system control commands include air intake valve control command 729, EGR valve control command 730 and VGT control command 731. The air charging system 704 is then controlled to operate based on these control commands to achieve the desired operating parameters.

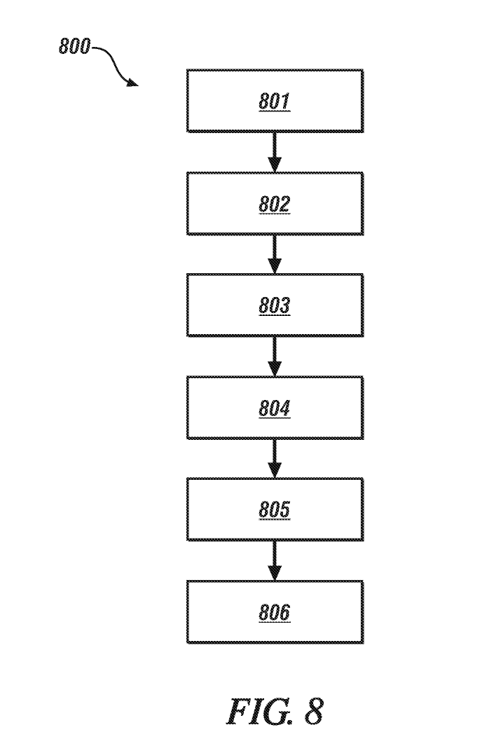

FIG. 8 depicts an exemplary process 800 to control an exhaust gas recirculation, an air throttle system, and an air charging system in an internal combustion engine, in accordance with the present disclosure. Table 1 is provided as a key wherein the numerically labeled blocks and the corresponding functions are set forth as follows.

TABLE 1

| BLOCK | BLOCK CONTENTS |
|---|---|
| 801 | Monitor desired operating target commands for each of the |
| | EGR system, the air throttle system, and the air charging |
| | system |
| 802 | Monitor operating parameters of the air charging system |
| 803 | Determine feedback control signals for each of the EGR |
| | system, the air throttle system and the air charging system |
| | based on the desired operating target commands and the |
| | operating parameters of the air charging system |
| 804 | Determine EGR flow, air flow and a turbine power |
| | parameter based upon any of the feedback control signals |
| | and desired operating target commands |
| 805 | Determine a system control command for each of the EGR |
| | system, air throttle system, and air charging system |
| 806 | Control the air charging system based on the system |
| | control commands |

In a system third order model with high pressure EGR the system control commands may alternatively be determined without the use of an inverse flow model or an inverse of a physical model of a system to determine settings required to achieve a desired flow through an orifice in the system. By creating a model of the system that replaces the W_{egr} term with the term CdA_{egr}, the model can determine system control commands without the implementation of inverse flow models or inverse of physical models of a system. An exemplary system model can be expressed as a nonlinear differential equation in accordance with the following relationship.

\dot{x}=C_{f}(t)x+C_{g}(t)u [19]

The system output vector x can be expressed by the following vector.

$$x = [ \begin{matrix}{p}_{i} \\ {F}_{i} \\ {p}_{rc}\end{matrix} ] \qquad [ 20 ]$$

The system input vector u can be expressed by the following vector.

$$u = [ \begin{matrix}{W}_{itv} \\ C d {A}_{egr} \\ {R}_{t}\end{matrix} ] \qquad [ 21 ]$$

A third exemplary three-state model in accordance with the basic system model relationships [1], [2] and [3] set forth above is set forth in the following set of relationships.

$$\begin{matrix}{\dot{p}}_{i} = \frac{R {T}_{i}}{{V}_{i}} ( {W}_{itv} + \frac{{p}_{x} {ξ}_{egr}}{\sqrt{R {T}_{x}}} C d {A}_{egr} - {W}_{e} ( {p}_{i} ) ) & [ 22 ] \\ {\dot{F}}_{i} = \frac{R {T}_{i}}{{p}_{i} {V}_{i}} ( \frac{{p}_{x} {ξ}_{egr}}{\sqrt{R {T}_{x}}} C d {A}_{egr} ( {F}_{x} - {F}_{i} ) - {F}_{i} {W}_{itv} ) & [ 23 ] \\ {\dot{p}}_{rc} = - c {P}_{c} + J ( {\dot{W}}_{itv} , {W}_{itv} ) + c {P}_{t} & [ 24 ]\end{matrix}$$

In relationships [22]-[24]:
Tᵢ is the temperature at the intake manifold,
R is the universal gas constant,
Vᵢ is the intake manifold volume
Wᵢₜᵥ is the air intake throttle valve flow,
pₓ is the pressure at the exhaust, and
Wₑ(pᵢ) is the total charge in the engine cylinder,

$$\frac{{p}_{x} {ξ}_{egr}}{\sqrt{R {T}_{x}}}$$

is written in accordance with the orifice flow relationship and the CdA_{egr} term replaces the W_{egr} term used in alternative system models, thus expressing the EGR valve position rather than the flow through the EGR valve,

Neglecting inertia effects of the turbo shaft in [24], J(\dot{W}ᵢₜᵥ, Wᵢₜᵥ), yields an approximation of \dot{p}_{rc} as follows:

\dot{p}_{rc}≈c(−P_{c}+hₜRₜ) [25]

wherein
Rt is the turbine power transfer rate and can be expressed by the following relationship:

$${R}_{t} = \frac{{P}_{t}}{{h}_{t}} \qquad [ 26 ]$$

wherein
   Pt is the turbine power, and
   hₜ is the exhaust energy flow and can be expressed by the following relationship:

hₜ=WₜcₚTₓ [27]
wherein
   Wₜ is the flow at the turbine,
   cₚ is specific heat under constant pressure, and
   Tₓ is the exhaust temperature.

The function C_{g}(t), as is stated in the basic system model of relationship [19] can be expressed by the following matrix.

$${C}_{g} ( t ) = [ \begin{matrix}\frac{R {T}_{i}}{{V}_{i}} & \frac{R {T}_{i}}{{V}_{i}} \frac{{p}_{x} {ξ}_{egr}}{\sqrt{R {T}_{x}}} & 0 \\ - \frac{R {T}_{i}}{{p}_{i} {V}_{i}} {F}_{i} & \frac{R {T}_{i}}{{p}_{i} {V}_{i}} \frac{{p}_{x} {ξ}_{egr}}{\sqrt{R {T}_{x}}} ( {F}_{x} - {F}_{i} ) & 0 \\ 0 & 0 & {ch}_{t}\end{matrix} ] \qquad [ 28 ]$$

And, the function C_{f} as is stated in the basic system model of relationship [19] can be expressed by the following matrix.

$${C}_{f} = [ \begin{matrix}- \frac{N D {η}_{v}}{2 {V}_{i}} & 0 & 0 \\ 0 & 0 & 0 \\ - c {P}_{c} & 0 & 0\end{matrix} ] \qquad [ 29 ]$$

This model defines an alternative means of determining the valve positions for the controls without having to use the inverse model as is required in other exemplary methods as described.

In the case that the system to be modeled includes low pressure EGR, a low pressure EGR relationship may be added as a fourth relationship into any of the three exemplary three-state models, resulting in a four-state model. This four state model may be addressed in a manner similar to any of the exemplary three-state models in accordance with the present disclosure. The low pressure EGR may be expressed by the following relationship.

m_{c}\dot{F}_{c}=F_{c}Wᵢₜᵥ+Fₓ(t−z)W_{egr,LP} [30]

wherein

m_{c} is the air mass at the low pressure EGR fix point,

F_{c} is the burned gas fraction at the low pressure EGR fix point,

Fₓ is the burned gas fraction the exhaust,

t is time,

z is a time delay, and

W_{egr,LP} is the low pressure EGR flow.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method to control an exhaust gas recirculation system, an air throttle system, and an air charging system in an internal combustion engine, the method comprising:
monitoring desired operating target commands for each of the exhaust gas recirculation system, the air throttle system, and the air charging system;
monitoring operating parameters of the air charging system;
determining a feedback control signal for each of the exhaust gas recirculation system, the air throttle system and the air charging system based upon the respective desired operating target commands and the operating parameters of the air charging system;
determining exhaust gas recirculation flow in the exhaust gas recirculation system, air flow in the air throttle system and a turbine power parameter in the air charging system based upon the respective feedback control signals for each of the exhaust gas recirculation system, the air throttle system and the air charging system;
determining a system control command for each of the exhaust gas recirculation system, the air throttle system, and the air charging system based upon the respective exhaust gas recirculation flow, air flow and turbine power parameter; and
controlling the air charging system based upon the system control commands for each of the exhaust gas recirculation system, the air throttle system, and the air charging system.

2. The method of claim 1, wherein the desired operating target commands comprise a desired intake manifold pressure command, a desired compressor pressure ratio command and a desired burned gas fraction command.

3. The method of claim 1, wherein the desired operating target commands comprise a desired intake manifold pressure command, a desired compressor pressure ratio command and a desired oxygen fraction command.

4. The method of claim 1, wherein the operating parameters of the air charging system comprise intake manifold pressure, intake manifold temperature, ambient pressure and ambient temperature.

5. The method of claim 1, wherein determining a feedback control signal for each of the exhaust gas recirculation system, the air throttle system and the air charging system based upon the respective desired operating target commands and the operating parameters of the air charging system comprises using a proportional-integral-derivative feedback control.

6. The method of claim 1, wherein determining a feedback control signal for each of the exhaust gas recirculation system, the air throttle system and the air charging system based upon the respective desired operating target commands and the operating parameters of the air charging system comprises using a linear quadratic regulator feedback control.

7. The method of claim 1, wherein determining a feedback control signal for each of the exhaust gas recirculation system, the air throttle system and the air charging system based upon the respective desired operating target commands and the operating parameters of the air charging system comprises using a model predictive feedback control.

8. The method of claim 1, wherein determining exhaust gas recirculation flow in the exhaust gas recirculation system, air flow in the air throttle system and turbine power in the air charging system based upon the respective feedback control commands for each of the exhaust gas recirculation system, the air throttle system and the air charging system is further based upon the monitored operating parameters of the air charging system.

9. The method of claim 1, further comprising determining a feed forward control command for each of the exhaust gas recirculation system, the air throttle system and the air charging system based upon the respective desired operating target commands for each of the exhaust gas recirculation system, the air throttle system, and the air charging system.

10. The method of claim 9, wherein determining exhaust gas recirculation flow in the exhaust gas recirculation system, air flow in the air throttle system and turbine power in the air charging system based upon the respective feedback control commands for each of the exhaust gas recirculation system, the air throttle system and the air charging system is further based upon the respective feed forward control commands for each of the exhaust gas recirculation system, the air throttle system and the air charging system.

11. The method of claim 1, wherein determining a system control command for each of the exhaust gas system, the air throttle system, and the air charging system based upon the respective exhaust gas recirculation flow, air flow and turbine power parameter comprises utilizing an inverse model of each respective system.

12. Method to control an exhaust gas recirculation system, an air throttle system, and an air charging system in an internal combustion engine, the method comprising:
providing a physics based air and charging system model of the internal combustion engine;
applying model-based nonlinear control to the physics based air and charging system model of the internal combustion engine;
applying feedback control to the physics based air and charging system model;
transforming desired air and charging targets for the air and charging system model to individual flow or power signals for each of an EGR actuator, an ITV actuator and a VGT actuator; and
determining an actuator position for each of the EGR actuator, ITV actuator and VGT actuator based upon the respective individual flow or power signals.

13. The method of claim 12, wherein applying model-based nonlinear control to the physics based air and charging system model of the internal combustion engine comprises applying physics model-based multivariable feedforward control to the physics based air and charging system model.

14. The method of claim 12, wherein applying model-based nonlinear control to the physics based air and charging system model of the internal combustion engine comprises applying state feedback linearization control to the physics based air and charging system model.

15. The method of claim 12, wherein applying feedback control to the physics based air and charging system model comprises using a proportional-integral-derivative feedback control.

16. The method of claim 12, wherein applying feedback control to the physics based air and charging system model comprises using a model predictive feedback control.

17. The method of claim 12, wherein applying feedback control to the physics based air and charging system model comprises using a linear quadratic regulator feedback control.

18. The method of claim 12, said physics based air and charging system model of the internal combustion engine comprises a system model in accordance with the following relationship:
\dot{y}=F(y)+Bu
wherein u is described by the following relationship:
u=−B⁻¹F(y)+B⁻¹v

19. The method of claim 18, wherein said system model is expressed by the following system relationships:
$${\dot{p}}_{rc} = - c {P}_{c} ( {p}_{rc} , \frac{{W}_{itv} \sqrt{{T}_{a}}}{{p}_{a}} ) + J ( {\dot{W}}_{itv} , {W}_{itv} ) + c {P}_{t}$$
$${\dot{p}}_{i} = \frac{R {T}_{im}}{{V}_{i}} ( {W}_{itv} + {W}_{egr} - {W}_{e} ( {p}_{i} ) )$$
$${\dot{F}}_{i} = \frac{( {F}_{x} - {F}_{i} ) {W}_{egr} - {F}_{i} {W}_{itv}}{{m}_{i}}$$
wherein
p_{rc} is a compressor pressure ratio expressed as p_{c}_{_}_{ds}/pₐ wherein p_{c}_{_}_{ds} is a compressor downstream pressure and pₐ is an ambient pressure,
c is a constant determined based on the relationship between the compressor pressure ratio and the square of the turbo speed,
P_{c} is a power being provided by the compressor,
$$\frac{{W}_{itv} \sqrt{{T}_{a}}}{{p}_{a}}$$
is an air throttle valve flow (Wᵢₜᵥ) corrected by an ambient temperature (Tₐ) and the ambient pressure (pₐ),
J(\dot{W}ᵢₜᵥ, Wᵢₜᵥ) is an inertia effect of the turbo shaft connecting the turbine to the compressor,
Pₜ is a turbine power,
pᵢ is an engine intake pressure at the intake manifold,
R is the universal gas constant,
Tᵢₘ is an intake manifold temperature,
Vᵢ is an intake manifold volume,
Wᵢₜᵥ is an air throttle valve flow,
W_{egr} is a flow through the EGR system,
Wₑ(pᵢ) is a total charge in an engine cylinder,
Fᵢ is a burned gas fraction in the intake manifold,
Fₓ is a burned gas fraction in the exhaust manifold, and
mᵢ is the mass in the intake manifold.

20. The method of claim 18, wherein the system model is expressed by the following system relationships:
$${\dot{p}}_{c\_ds} = \frac{c {T}_{c\_ds}}{{v}_{int}} ( {W}_{c} - {W}_{itv} ) = \frac{c {T}_{c\_ds}}{{v}_{int}} ( \frac{{h}_{t} {R}_{t}}{{c}_{p} {T}_{c\_us} {R}_{c}} - {W}_{itv} )$$
$${\dot{p}}_{i} = \frac{R {T}_{im}}{{V}_{i}} ( {W}_{itv} + {W}_{egr} - {W}_{e} ( {p}_{i} ) ) \\ {\dot{F}}_{i} = \frac{( {F}_{x} - {F}_{i} ) {W}_{egr} - {F}_{i} {W}_{itv}}{{m}_{i}}$$
wherein
p_{c}_{_}_{ds} is a pressure downstream of the compressor,
c is a constant determined based on the relationship between a compressor pressure ratio and a square of the turbo speed,
T_{c}_{_}_{ds} is a temperature downstream of the compressor,
T_{c}_{_}ᵤₛ is a temperature upstream of the compressor,
W_{c} is a flow out of the compressor,
Vᵢₙₜ is a volume of the intake manifold,
Rₜ is a turbine power transfer rate,
R_{c} is a compressor power increase ratio,
pᵢ is an engine intake pressure at the intake manifold,
R is the universal gas constant,
Tᵢₘ is an intake manifold temperature,
Vᵢ is an intake manifold volume,
Wᵢₜᵥ is an air throttle valve flow,
W_{egr} is a flow through the EGR system,
Wₑ(pᵢ) is a total charge in an engine cylinder,
Fᵢ is a burned gas fraction in the intake manifold,
Fₓ is a burned gas fraction in the exhaust manifold, and
mᵢ is the mass in the intake manifold.

21. Method to control an exhaust gas recirculation (EGR) system, an air throttle system, and an air charging system in an internal combustion engine, the method comprising:
providing a physics based air and charging system model of the internal combustion engine, including the exhaust gas recirculation system, the air throttle system, and the air charging system;
applying physics model-based multivariable feedforward control to the physics based air and charging system model;
applying feedback control to the physics based air and charging system model, the feedback control comprising one of a proportional-integral-derivative feedback control method, a linear quadratic regulator feedback control method, and a model predictive feedback control;
transforming desired operating target commands for each of the EGR system, the air throttle system, and the air charging system to a corresponding EGR flow, air flow, and turbine power parameter; and
transforming the EGR flow, the air flow, and the turbine power parameter into a corresponding actuator position for each of an EGR actuator, an ITV actuator and a VGT actuator using respective inverse models of each of the exhaust gas recirculation system, air throttle system, and air charging system.
